(19) United States
(12) Patent Application Publication
(10) Pub. No.: US 2026/0244209 A1
(43) Pub. Date: Aug. 20, 2026

(54) Mobile Body Control System

(71) Applicant: Hitachi High-Tech Corporation, Minato-ku, Tokyo (JP)

(72) Inventors: Ryo KOYAMA, Tokyo (JP); Masahiro KOYAMA, Tokyo (JP); Tomohiro INOUE, Tokyo (JP); Shinichi ISHIKAWA, Tokyo (JP)

(21) Appl. No.: 19/160,651

(22) PCT Filed: Jun. 23, 2023
(86) PCT No.: PCT/JP2023/023418

§ 371 Date: Aug. 28, 2025

(51) Int. Cl. G05D 1/622; G05D 1/24; G05D 1/85; G05D 105/70; G05D 107/70; G05D 109/10; G05D 111/10

(52) U.S. Cl. CPC G05D 1/622; G05D 1/24; G05D 1/85; G05D 2105/70; G05D 2107/70; G05D 2109/10; G05D 2111/17

(57) ABSTRACT

A mobile body control system in which a user can set an operation rule of a mobile robot so that the mobile robot can move without interfering with work performed at a specific place is provided. A mobile body control system 1 includes a first mobile body setting portion 121, a region setting portion 122 configured to set a first region 3 and a second region 5, a second mobile body detection unit 125 configured to acquire detection information of a second mobile body 4, an operation mode setting portion 123 configured to set an operation mode of a first mobile body 2, an operation mode selection rule setting portion 124 configured to set an operation mode selection rule, a setting information storage unit 150 configured to store setting information of the operation mode selection rule, a first mobile body position estimation unit 126 configured to estimate a position of the first mobile body, and a first mobile body control unit 127 configured to select the operation mode

### TECHNICAL FIELD

The present disclosure relates to a mobile body control system that controls a mobile body.

### BACKGROUND ART

Due to the shortage of labor and the spread of workstyle reforms in recent years, there is a growing need for automation and labor-saving measures in a variety of worksites. In particular, mobile robots, which are mobile bodies, have been used in the fields of non-manufacturing industries such as logistics and medical care with the background of the development of sensors and AI, and it is considered that there will be an increasing number of cases where the mobile robots are operated in the same space as workers.

There is an interference avoidance control technology as one of technologies that have been actively researched and developed in order for a mobile robot to travel in an environment in which the mobile robot coexists with humans and another mobile bodies (for example, other robots) (see PTLs 1 and 2).

In interference avoidance control, generally, information acquired by a sensor is received, and a controlled variable such as a traveling speed or a direction is determined so as to appropriately secure a distance to a human or an obstacle.

PTL 1 discloses an electronic control device that measures a width of a human or a mobile body present in a traveling direction of a robot and a width of a passage, stops the robot when it is determined that the robot and the human or the mobile body can pass each other, and evacuates the robot when the robot and the human or the mobile body cannot pass each other.

PTL 2 exemplifies, as input information used for a robot to smoothly pass a human without interfering with the human, “information on a country or cultural region associated with the human, a moving direction of the human, a moving speed of the human, physical information of the human, information on a passage through which the human passes, a distance between the human and the robot, a type of service provided by the robot, a type of the robot, and a speed of the robot”. Further, PTL 2 discloses a robot control method of “controlling movement of a robot so as to avoid interference with a human” based on “a personal region associated with the human present in a traveling direction of the robot”.

In addition, as a technique for a mobile robot to travel in an environment where the mobile robot coexists with a human, there is a technique having a purpose different from interference avoidance (see PTL 3).

PTL 3 discloses a control device that “acquires detection information of a user present in a preset area of a facility” and controls a robot to operate “at a set maximum operation speed or less based on the detection information of the user” in order to “achieve both work efficiency and noise reduction of a task by the robot”.

As described above, according to the related art, it is possible to operate the mobile robot so as not to interfere with a human or another mobile body. In addition, it is also possible to apply, to the mobile robot, a simple rule common to areas that “when a human is present in the area, the mobile robot is caused to travel at a low speed”.

### CITATION LIST

### Patent Literature

PTL 1:: JP2012-22467A

PTL 2: JP2021-64372A

PTL 3: JP2022-102061A

### SUMMARY OF INVENTION

### Technical Problem

However, according to the above-described related art intended only to avoid interference, a mobile robot may hinder work of another worker or robot. For example, when a mobile robot approaches a worker who is about to open and close a door of a locker in a narrow passage, the mobile robot stops on the spot so as not to interfere with the worker, which may hinder opening and closing of the door of the locker. That is, the mobile robot may hinder the work of the worker.

Therefore, there may be a method of adjusting conventional interference avoidance control to secure a sufficiently wide distance between the mobile robot and the worker. However, in this case, since the mobile robot operates so as to secure a sufficient distance from surrounding workers in the entire traveling region, frequent stops or excessive avoidance traveling is caused when traveling on a normal passage.

Further, in a general worksite, different work is often performed in adjacent areas, and work content of the worker encountered by the mobile robot during traveling is not limited to one type. In addition, the content and the number of types of work vary depending on the worksite. Therefore, the desirable operation of the mobile robot also vary depending on the work content performed at each worksite.

It is considered that the convenience of the mobile robot is improved if the user can easily set the operation of the mobile robot suitable for each worksite, but in the related art, such a setting means does not exist. Therefore, in the interference avoidance control of the related art, it is difficult to sufficiently cope with a situation where different types of work are performed in a plurality of areas.

An object of the present disclosure is to provide a mobile body control system in which a user can set an operation rule of a mobile robot so that the mobile robot can move without interfering with work performed at a specific place.

### Solution to Problem

The present inventor has focused on a fact that, for various types of work in a general worksite, a place where each type of work is to be performed is determined, and has found that, by setting a rule for the mobile robot to select an operation mode in association with a work region and the presence or absence and a state of a human present in the work region, it is possible to select an appropriate operation mode for the mobile robot not to hinder the work performed in the work region.

The subject that performs work in the work region is not limited to a human worker, and may be a mobile body operated by a human or another mobile robot that performs work. Therefore, hereinafter, the mobile robot to be controlled is referred to as a first mobile body, and a subject that performs work separately from the first mobile body is referred to as a second mobile body. The entire region where the first mobile body moves is referred to as a first region, and a work region where the second mobile body performs work is referred to as a second region. The present disclosure is particularly effective when the second region is present inside the first region, and therefore, in the following description, unless otherwise specified, it is assumed that the second region is present inside the first region.

An embodiment according to the present disclosure based on this idea is a mobile body control system for controlling a mobile body that moves in at least one region, the mobile body control system including: a first mobile body setting portion for setting shape information of a first mobile body based on an operation of a user; a region setting portion for displaying a first region that is a region in which the first mobile body moves and a second region that is a closed region inside the first region, and setting the first region and the second region based on an operation of the user; a second mobile body detection unit configured to acquire detection information regarding presence or absence and a state of a second mobile body present in the second region; an operation mode setting portion for displaying information on an operation mode defining a determination method of at least one of a moving direction and a speed when the first mobile body moves in the first region, and setting the operation mode based on an operation of the user; an operation mode selection rule setting portion for displaying an operation mode selection rule that is information on a rule for selecting the operation mode according to the detection information of the second region, and setting the operation mode selection rule according to an operation of the user; a setting information storage unit configured to store the shape information of the first mobile body and setting information of the first region, the second region, the operation mode, and the operation mode selection rule; a first mobile body position estimation unit configured to estimate and output position information of the first mobile body in the first region; and a first mobile body control unit configured to select the operation mode according to the setting information stored in the setting information storage unit and perform operation planning and control of the first mobile body.

Another embodiment of the present disclosure is a mobile body control system for controlling a first mobile body that moves in a first region, the mobile body control system including: a region setting portion configured to set a second region that is a closed region inside the first region; a second mobile body detection unit configured to detect a state of a second mobile body present in the second region; an operation mode setting portion configured to set, by an operation of a user, content of an operation mode defining a movement condition when the first mobile body moves in the first region; and a first mobile body control unit configured to select the operation mode based on a detection result of the second mobile body detection unit and control the first mobile body based on the selected operation mode.

### Advantageous Effects of Invention

According to the present disclosure, it is possible to provide a mobile body control system in which a user can set an operation rule of a first mobile body so that the first mobile body moving in a first region can move without interfering with work performed by a second mobile body in a second region inside the first region. In other words, it is possible to provide the mobile body control system in which a user can set an operation rule of a mobile robot so that the mobile robot can move without interfering with work performed by a worker at a specific place.

### BRIEF DESCRIPTION OF DRAWINGS

FIG. 1 is a diagram schematically illustrating an external entity with which a mobile body control system according to Embodiment 1 is involved.

FIG. 2 is a diagram illustrating a physical configuration of the mobile body control system according to Embodiment 1.

FIG. 3 is a diagram illustrating the physical configuration of the mobile body control system according to Embodiment 1.

FIG. 4 is a block diagram illustrating a functional configuration of the mobile body control system according to Embodiment 1.

FIG. 5 is a diagram illustrating a screen layout of a display device according to Embodiment 1.

FIG. 6 is a diagram illustrating a display screen of the display device according to Embodiment 1.

FIG. 7 is a diagram illustrating an operation screen of a first mobile body setting portion according to Embodiment 1.

FIG. 8 is a diagram illustrating an operation screen of a region setting portion according to Embodiment 1.

FIG. 9 is a diagram illustrating an operation screen of an operation mode setting portion according to Embodiment 1.

FIG. 10 is a diagram illustrating an operation screen of an operation mode selection rule setting portion according to Embodiment 1.

FIG. 11 is a diagram illustrating an operation screen of an operation mode selection rule setting portion according to Embodiment 2.

FIG. 12 is a diagram illustrating an operation screen of an operation mode selection rule setting portion according to Embodiment 3.

FIG. 13 is a diagram illustrating an operation screen of an operation mode selection rule setting portion according to Embodiment 4.

FIG. 14 is a diagram illustrating an operation screen of a region setting portion according to Embodiment 5. FIG. 15 is a diagram illustrating a state transition of a first mobile body control unit according to Embodiment 6.

FIG. 16 is a diagram illustrating a mobile body control system according to Embodiment 7.

FIG. 17 is a diagram illustrating a mobile body control system according to Embodiment 8.

FIG. 18 is a diagram illustrating a display screen of an operation mode selection rule setting portion according to Embodiment 9.

FIG. 19 is a diagram illustrating a state transition of a mobile body control system according to Embodiment 9.

### DESCRIPTION OF EMBODIMENTS

Hereinafter, embodiments of the present disclosure will be described in detail with reference to the drawings. The embodiments are merely examples for describing the present disclosure, do not limit the present disclosure, and are appropriately omitted and simplified for clarity of the description. The present disclosure can also be implemented in various other examples and examples in which some or all of the examples are combined. Unless otherwise specified, each component may be single or plural. In addition, in the following description of the embodiments, differences from the previously described embodiments will be mainly described, and a description of repeated portions will be appropriately omitted. In addition, in each embodiment, an implementation example of a graphical user interface may be shown by a drawing, and the position, order, and hierarchical structure of elements constituting the user interface are not limited.

### Embodiment 1

(External Entity with Which Mobile Body Control System Is Involved)

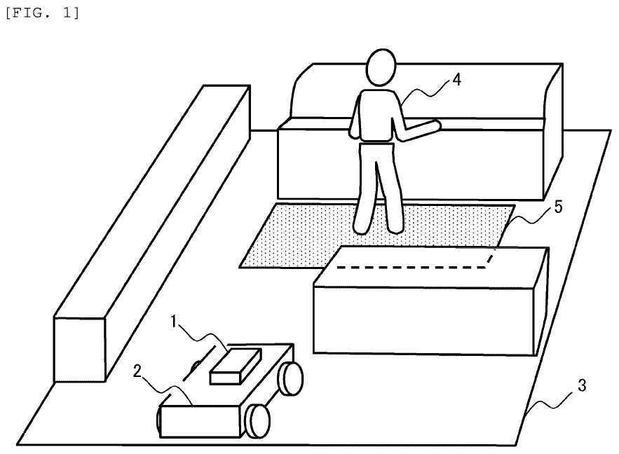

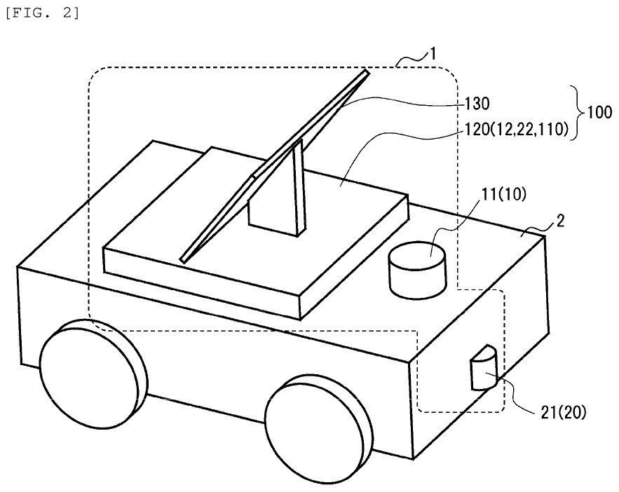

FIG. 1 is a diagram schematically illustrating an external entity with which a mobile body control system according to Embodiment 1 is involved.

A mobile body control system according to the present disclosure is a system for controlling a first mobile body that moves in a preset first region. As illustrated in FIG. 1, a mobile body control system 1 involves a first mobile body 2, a first region 3, a second mobile body 4, and a second region 5 as external entities (entities). The mobile body control system 1 according to Embodiment 1 is mounted on the first mobile body 2 moving in the first region 3 and controls an operation of the first mobile body 2.

Although not illustrated, the mobile body control system 1 is communicably connected to the first mobile body 2 in a wired or wireless manner. Although FIG. 1 illustrates a configuration in which the mobile body control system 1 is mounted on the first mobile body 2, the mobile body control system 1 may be partially or entirely provided outside the first mobile body 2.

The first mobile body 2 is a mobile robot and is an object to be controlled by the mobile body control system 1 according to Embodiment 1. The first mobile body 2 is, for example, a wheeled mobile robot, and a wheel drive system may be any system. Examples of the wheel drive systems include a two-wheel actuation system, an omni-wheel system, a Mecanum wheel system, and a steering system. The first mobile body 2 is not limited to a wheeled mobile robot, and may be, for example, a legged robot.

The first region 3 is a closed region in which the first mobile body 2 moves, and is set in advance by a user, for example. The first region 3 is set, for example, as a part or the whole of a work area of a factory. The first region 3 may be set as a part or the whole of a floor in a building of a distribution warehouse. The first region 3 may be set as a part or the whole of an examination room in a medical institution. The first region 3 may be set as an outdoor carry-in/out work area of a factory.

The second mobile body 4 is a mobile body different from the first mobile body 2 that moves in the first region 3. The second mobile body 4 is, for example, a human worker. The second mobile body 4 may be a mobile robot. The second mobile body 4 may be a vehicle operated by a worker, such as a forklift.

The second region 5 is a closed region inside the first region 3 set by the user, and is set as, for example, a space for the second mobile body 4 as a worker to perform work. In a general worksite, the space where work is performed is often divided according to the work content. The user sets the second region 5 as a space for performing each type of work so that the second mobile body 4 performs a desired operation. The second region 5 is set, for example, as a region around a workbench on which the worker performs specific work. The second region 5 may be set as a region around equipment having an opening/closing door such as a locker or a medical analysis device. The second region 5 may be set as a passage or a space where the worker frequently comes and goes only during work. The second region 5 may be set as a space where the mobile robot performs some work. The second region 5 may be set as a space for loading and unloading cargos by a forklift.

### (Physical Configuration of Mobile Body Control System)

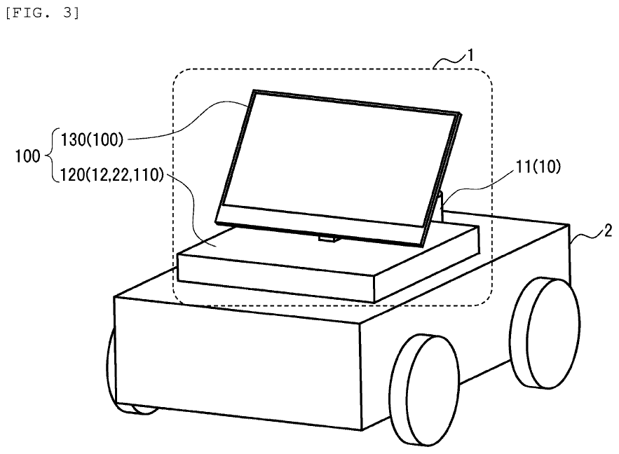

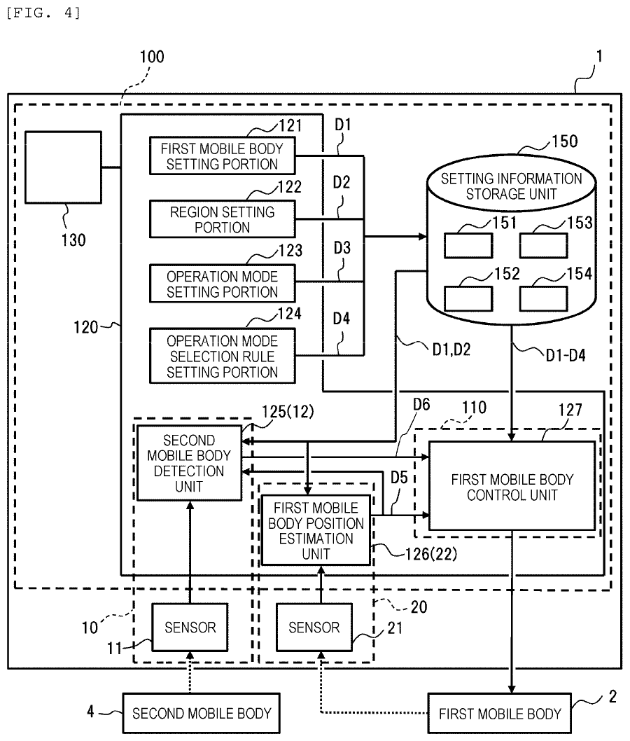

FIGS. 2 and 3 are diagrams illustrating a physical configuration of the mobile body control system according to Embodiment 1. As illustrated in FIGS. 2 and 3, the mobile body control system 1 is mounted on the first mobile body 2 that is a mobile robot. The mobile body control system 1 includes, as physical configurations, a second mobile body detection device 10, a first mobile body position estimation device 20, a setting device 100, and a control device 110.

The second mobile body detection device 10 includes a second mobile body detection sensor 11 and a signal processing module (signal processing device) 12, and is a component that detects presence or absence of the second mobile body 4 and a state of the second mobile body 4 in a preset region. As will be described in detail later, the second mobile body detection device 10 detects the presence or absence of the second mobile body 4 present in the second region 5 and the state of the second mobile body 4.

The second mobile body detection sensor 11 is, for example, light detection and ranging (LiDAR) mounted on the first mobile body 2. A type of the second mobile body detection sensor 11 is not particularly limited as long as the second mobile body detection sensor 11 can detect the second mobile body 4. The second mobile body detection sensor 11 may be, for example, an ultrasonic sensor. The second mobile body detection sensor 11 may be, for example, a camera (image sensor).

The second mobile body detection sensor 11 may not necessarily be mounted on the first mobile body 2. The second mobile body detection sensor 11 may be a pressure sensor installed on a floor of the second region 5, or may be a pressure sensor installed on a chair on which a worker as the second mobile body 4 sits.

Further, the configuration of the second mobile body detection device 10 is not particularly limited as long as the second mobile body detection device 10 can detect the second mobile body 4. The second mobile body detection device 10 may detect the presence or absence of the second mobile body 4 by a beacon or an acceleration sensor built in a device owned by the second mobile body 4. The second mobile body detection device 10 may include a camera, a beacon, or an ultrasonic sensor fixed to a wall or equipment near the second region 5, or other non-contact sensors capable of detecting the presence or absence of the second mobile body.

The signal processing module 12 constituting the second mobile body detection device 10 is a computer including a calculation unit, a RAM unit, a storage unit, a communication unit, and the like, and is configured as a part of a calculation device 120 constituting the setting device 100 in the embodiment. The signal processing module 12 may be configured as one device independent of the calculation device 120.

The first mobile body position estimation device 20 includes, for example, a first mobile body position estimation sensor 21 and a signal processing module 22, and estimates a position of the first mobile body 2 in a preset region. The first mobile body position estimation device 20 estimates and outputs the position of the first mobile body 2 moving in the first region 3. The first mobile body position estimation sensor 21 is, for example, a LiDAR mounted on the first mobile body 2.

A type of the first mobile body position estimation sensor 21 is not particularly limited as long as the first mobile body position estimation sensor 21 can detect the position of the first mobile body 2. As the first mobile body position estimation sensor 21, for example, the same sensor as the second mobile body detection sensor 11 can be used. However, the first mobile body position estimation sensor 21 may be different from the second mobile body detection sensor 11.

The configuration of the first mobile body position estimation device 20 is not particularly limited as long as the first mobile body position estimation device 20 can estimate or detect the position of the first mobile body 2. The first mobile body position estimation sensor 21 may be installed outside the first mobile body 2 so that the first mobile body 2 can be observed.

The signal processing module (signal processing device) 22 constituting the first mobile body position estimation device 20 is a computer including functional units similarly to the signal module of the second mobile body detection device 10, and is configured as a part of the calculation device 120 of the setting device 100 in the embodiment. The signal processing module 22 may be configured as one device independent of the calculation device 120.

The setting device 100 is, for example, a personal computer, includes the calculation device 120 and an input and output device 130 as a user interface, and is mounted on the first mobile body 2. The calculation device 120 includes a calculation unit such as a central processing unit (CPU), a random access memory (RAM) unit such as a semiconductor memory, a storage unit such as a solid state drive (SSD) or a hard disk drive (HDD), and a communication unit, and the like. Instead of a CPU, the calculation device 120 may use processing devices such as a programmable logic device (PLD) like a field programmable gate array (FPGA) or an application specific integrated circuit (ASIC).

The input and output device 130 includes, for example, a display and a keyboard. Alternatively, as the input and output device 130, a touch panel type display may be used so that the user can perform setting by an intuitive touch operation.

The setting device 100 may be detachably provided with respect to the first mobile body 2, or may be physically separated from the first mobile body 2. That is, the setting device 100 may be provided at a place different from the first mobile body 2. In this case, the setting device 100 includes a means for communicating with other components of the mobile body control system 1 mounted on the first mobile body 2. The setting device 100 may include, for example, a mobile terminal such as a smartphone or a tablet. In this case, the user can set the mobile body control system 1 at any position, and the convenience is improved.

As will be described in detail later, the control device 110 controls the first mobile body 2. The control device 110 includes a calculation unit, a RAM unit, a storage unit, a communication unit, and the like, similarly to the calculation device 120 of the setting device 100. In the embodiment, the control device 110 is configured as a part of the calculation device 120 of the setting device 100. Of course, the control device 110 may be configured as one device independent of the calculation device 120.

### (Functions of Mobile Body Control System)

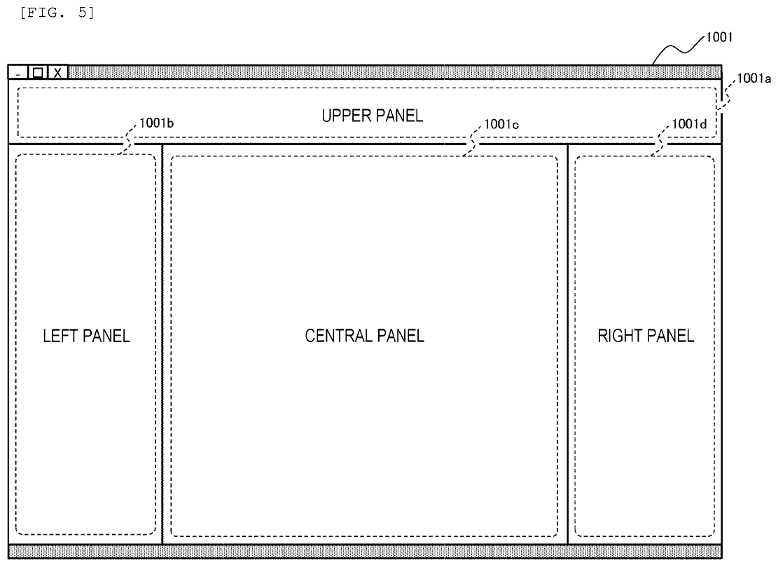

Next, functions of the mobile body control system 1 will be described. FIG. 4 is a diagram illustrating an example of functional blocks of the mobile body control system.

The mobile body control system 1 is a system that controls the first mobile body 2 so as not to hinder the work of the second mobile body 4, and includes the second mobile body detection device 10, the first mobile body position estimation device 20, the setting device 100, and the control device 110 as illustrated in FIG. 4. The setting device 100 includes the calculation device 120, the input and output device 130, and a setting information storage unit 150. The calculation device 120 also functions as the signal processing modules 12 and 22 and the control device 110 as described above.

The calculation device 120 includes a first mobile body setting portion 121, a region setting portion 122, an operation mode setting portion 123, an operation mode selection rule setting portion 124, a second mobile body detection unit 125, a first mobile body position estimation unit 126, and a first mobile body control unit 127.

The elements constituting the mobile body control system 1 are configured to be communicable. A communication method between the elements constituting the mobile body control system 1 is not particularly limited, and may be, for example, an address reference on a random access memory (RAM) such as a semiconductor memory, wired parallel/serial communication, or wireless serial communication.

The first mobile body setting portion 121, the region setting portion 122, the operation mode setting portion 123, and the operation mode selection rule setting portion 124 that function as the setting device 100 are elements constituting, for example, a graphical user interface (GUI). Using these setting portions, the user performs various settings so that the first mobile body 2 performs a desired operation. The first mobile body setting portion 121, the region setting portion 122, the operation mode setting portion 123, and the operation mode selection rule setting portion 124 may be implemented by a command group of a command line interface (CLI).

The setting information storage unit 150 includes a first mobile body setting storage unit 151, a region setting storage unit 152, an operation mode setting storage unit 153, and an operation mode selection rule setting storage unit 154. The storage units are non-volatile storage devices that sequentially store setting information set by the first mobile body setting portion 121, the region setting portion 122, the operation mode setting portion 123, and the operation mode selection rule setting portion 124. The setting information storage unit 150 is, for example, a storage device such as a solid state drive (SSD), a hard disk drive (HDD), or a flash memory.

The second mobile body detection unit 125 corresponds to the signal processing module 12 and functions as the second mobile body detection device 10. That is, the second mobile body detection unit 125 detects the presence or absence of the second mobile body 4 present in the second region 5 and the state of the second mobile body 4 based on a signal of the sensor 11. In other words, the second mobile body detection unit 125 acquires detection information on the second mobile body 4 present in the second region 5 and the state of the second mobile body.

The first mobile body position estimation unit 126 corresponds to the signal processing module 22 and functions as the first mobile body position estimation device 20. That is, the first mobile body position estimation unit 126 estimates or detects the position of the first mobile body 2 in the first region 3 based on a signal of the sensor 21 and outputs the position.

The first mobile body control unit 127 functions as the control device 110, and controls the first mobile body 2 while communicating with the second mobile body detection unit 125, the first mobile body position estimation unit 126, and the setting information storage unit 150. As will be described in detail later, the first mobile body control unit 127 selects an operation mode according to the setting information stored in the setting information storage unit 150, and performs operation planning of the first mobile body 2 and control of the first mobile body 2 based on an operation plan.

(Internal Processing Procedure of Mobile Body Control System) Subsequently, an internal processing procedure of the mobile body control system 1 including the above elements will be described. When controlling the first mobile body, the user performs various types of settings necessary for controlling the first mobile body as advance setting work. First, the user writes shape information D1 of the first mobile body 2 in the first mobile body setting storage unit 151 of the setting information storage unit 150 by using the first mobile body setting portion 121.

The shape information D1 of the first mobile body 2 includes dimensions such as a width (vehicle width), a length (vehicle length), a tread, and a wheel base of a vehicle body constituting the first mobile body 2. The shape information D1 may include, for example, information on vehicle body coordinates, more specifically, information on coordinates of the first mobile body position estimation sensor 21 mounted on the vehicle body of the first mobile body 2. The shape information D1 may include information on coordinates of the second mobile body detection sensor 11 mounted on the vehicle body of the first mobile body 2. The information on coordinates is, for example, information on positions x, y, and z and three-dimensional rotational postures Rx, Ry, and Rz based on coordinates of a center of the vehicle body representing the first mobile body 2. Further, the shape information D1 may include a CAD model or the like constituting a link of the first mobile body 2.

Next, the user sets the first region 3 using the region setting portion 122. The region setting portion 122 reads, for example, a 2D map of the first region 3 generated in advance by a Simultaneous Localization and Mapping (SLAM) function of the first mobile body position estimation unit 126 according to an operation of the input and output device 130 by the user, and displays the 2D map on a display constituting the input and output device 130. The user sets the second region 5 in the first region 3 by using the region setting portion 122. Region information D2 related to the setting of the first region 3 and the second region 5 is written in the region setting storage unit 152. The region information D2 includes, for example, image data of the 2D map of the first region 3, a sequence (xi, yi) (i=0,1,2 . . . ) of coordinates of vertices defining a closed region of the second region 5, and a character string that is an identifier of the first region 3 and the second region 5.

Further, the user sets an operation mode defining a determination method of at least one of a moving direction and a speed of the first mobile body 2 by using the operation mode setting portion 123. The information (operation mode information) D3 on the operation mode set using the operation mode setting portion 123 by the user's operation has at least a name of the operation mode as a character string, and is stored in the operation mode setting storage unit 153.

When the operation mode information D3 is already stored in the operation mode setting storage unit 153, the user can also view the predetermined operation mode information D3 by using the operation mode setting portion 123. In the case of a predetermined operation mode, the operation mode information D3 may only include a name of the operation mode defined in advance by a developer.

The user can also set a unique operation mode by individually setting parameters included in the predetermined operation mode. The operation mode information D3 with such parameters includes data of parameters prepared by the developer.

As a last operation in the advance setting work, the user sets information (operation mode selection rule information) D4 on an operation mode selection rule, in which a condition for selecting the operation mode is associated with the region information D2 of the second region 5 and the operation mode information D3, by using the operation mode selection rule setting portion 124, and writes the information into the operation mode selection rule setting storage unit 154.

When the advance setting work by the user is completed, the first mobile body control unit 127 controls the operation of the first mobile body 2 in the first region 3 based on the setting content. A method of controlling the first mobile body 2 by the first mobile body control unit 127 is based on the following processing.

First, the first mobile body control unit 127 acquires first mobile body position information D5 from the first mobile body position estimation unit 126. The first mobile body position information D5 includes a current position (x, y) [m] and a current posture 0 [deg] of the first mobile body 2 on the map displayed on the display, that is, in the first region 3.

Subsequently, the first mobile body control unit 127 reads the region information D2 from the region setting storage unit 152 and specifies the second region 5 present in the vicinity of the first mobile body 2. Further, the first mobile body control unit 127 acquires second mobile body detection information D6 regarding the presence or absence of the second mobile body 4 inside the second region 5 specified by the second mobile body detection unit 125 and the state of the second mobile body 4. The position of the second mobile body 4 measured in the sensor coordinate system is integrated with a detection result of the sensor 21, the shape information D1 of the first mobile body 2, and the first mobile body position information D5 by the second mobile body detection unit 125 corresponding to the signal processing module 12, and is converted into a map coordinate system.

The first mobile body control unit 127 reads the operation mode selection rule information D4 from the operation mode setting storage unit 153 and compares the acquired second mobile body detection information D6 with the operation mode selection rule information D4 to select an appropriate operation mode. Finally, the first mobile body control unit 127 switches the operation mode of the first mobile body 2 to the selected operation mode, performs operation planning for the first mobile body 2 by using an algorithm corresponding to the switched operation mode, and transmits a control command to the first mobile body 2 so as to implement the planned operation.

### (Operation Procedure of Setting Device)

Next, an operation procedure of the setting device 100 will be described. In the following description, although a tap operation and a drag operation on the touch panel type display may be exemplified, an operation method of the setting device 100 is not limited, and the input and output device 130 for operation is not limited to the touch panel type display. The operations may be implemented by combining operations such as a tap, a double tap, a long press, a drag, and a swipe on a screen of the touch panel. In addition, the operations may be implemented by operation of an input device such as a mouse, a stylus pen, or a trackball.

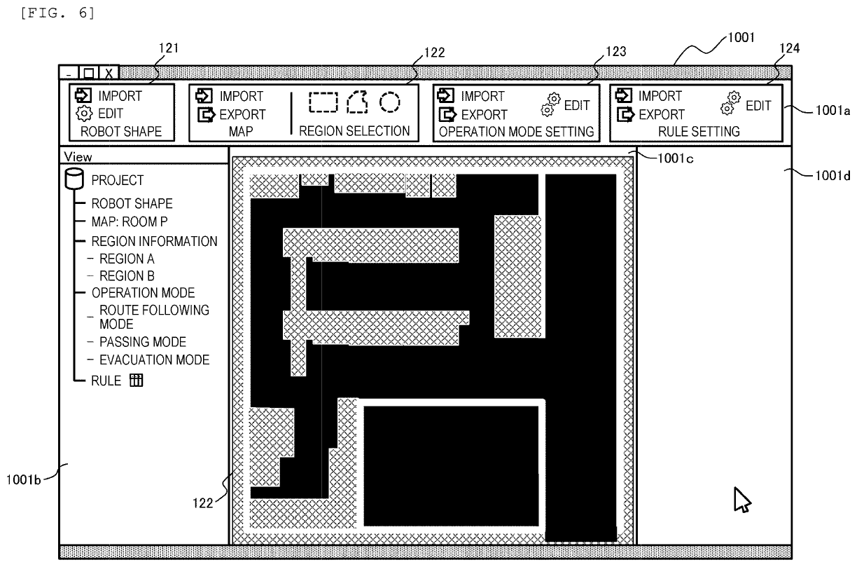

FIG. 5 is a diagram illustrating an example of a screen layout of the input and output device according to Embodiment 1. As illustrated in FIG. 5, an operation screen 1001 as a user interface is displayed on the display provided in the input and output device 130. The operation screen 1001 includes four panels of an upper panel 1001a, a left panel 1001b, a central panel 1001c, and a right panel 1001d, and GUI elements for setting are displayed in each panel portion in accordance with an operation of the user.

A purpose of defining the layout configuration here is to facilitate indication of components in the drawing, and the layout of the operation screen 1001 is not limited to the layout illustrated in FIG. 5.

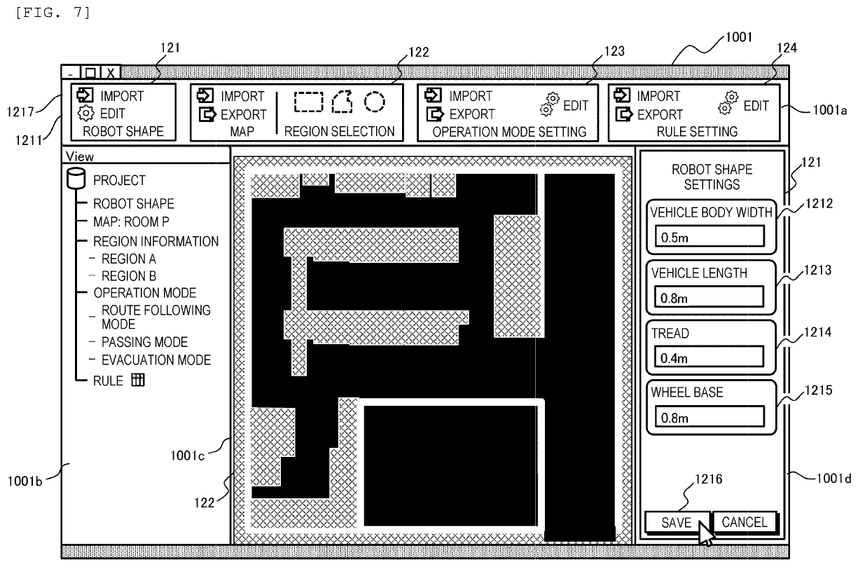

FIG. 6 is a diagram illustrating an example of an operation screen of the input and output device according to Embodiment 1. As illustrated in FIG. 6, the first mobile body setting portion 121, the region setting portion 122, the operation mode setting portion 123, and the operation mode selection rule setting portion 124 are provided on the upper panel 1001a of the operation screen 1001. The data stored in the setting information storage unit 150 is schematically displayed on the left panel 1001b of the operation screen 1001. The region setting portion 122 is provided not only on the upper panel 100la but also on the central panel 1001c, and a map of the first region 3 is displayed on the central panel 1001c, which will be described in detail later. In the example illustrated in FIG. 6, the right panel 1001d is blank.

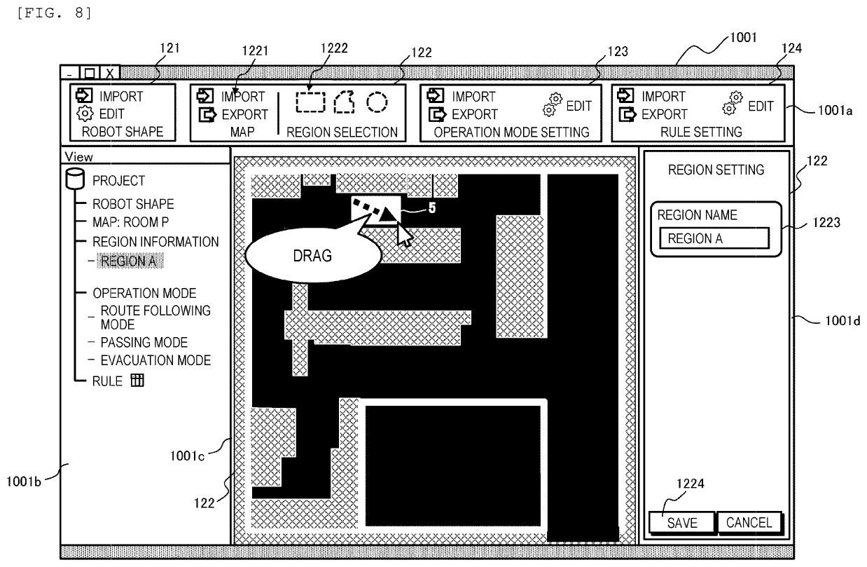

FIG. 7 is a diagram illustrating an example of a display screen of the first mobile body setting portion according to Embodiment 1. When writing the shape information D1 of the first mobile body 2, the user first presses an edit button 1211 of the first mobile body setting portion 121 provided on the upper panel 1001a of the operation screen 1001. Accordingly, a setting portion for setting the shape information D1 of the first mobile body 2 is displayed on the right panel 1001d. As an example, a vehicle body width setting portion 1212, a vehicle length setting portion 1213, a tread setting portion 1214, and a wheelbase setting portion 1215 are displayed on the right panel 1001d as setting portions. The user sets the shape information d1 of the first mobile body 2 by inputting numerical values in text boxes of these setting portions.

Thereafter, the user presses a save button 1216 in a lower portion of the right panel 1001d. Accordingly, the input data of the shape information D1 is written in the first mobile body setting storage unit 151. Other data constituting the shape information D1 of the first mobile body 2 is set by pressing an import button 1217 of the first mobile body setting portion 121 of the upper panel 1001a and reading a text file or a binary file in which data is written in advance. Conversely, the information stored in the first mobile body setting storage unit 151 is displayed by the first mobile body setting portion 121 of the right panel 1001d, for example.

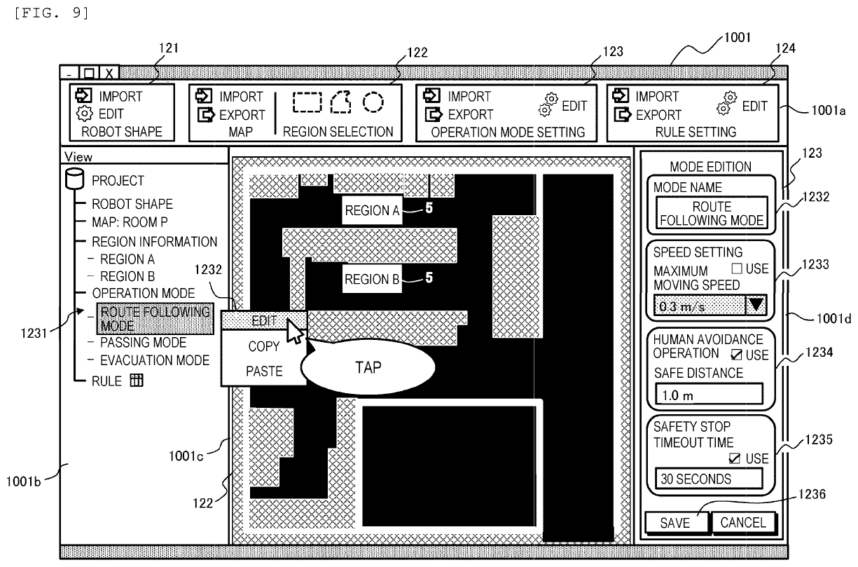

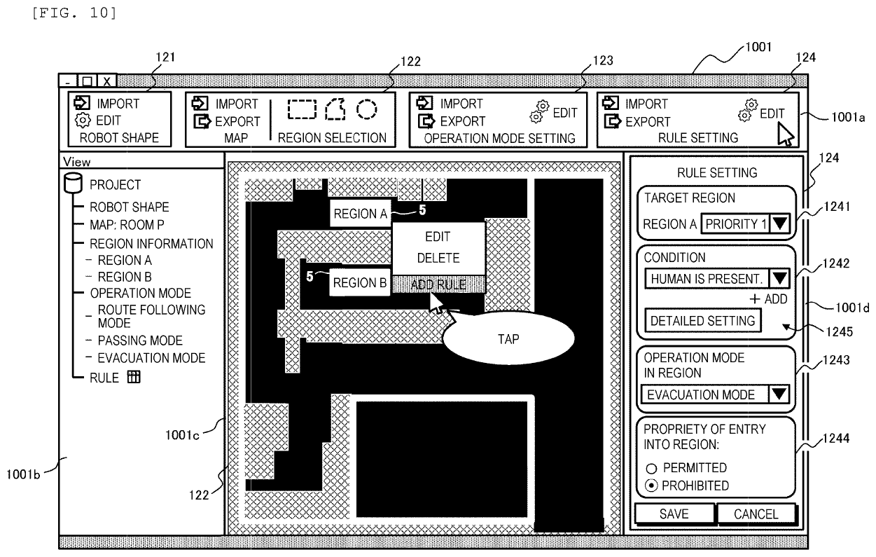

FIG. 8 is a diagram illustrating an example of a display screen of the region setting portion according to Embodiment 1. When setting the first region 3, the user first presses an import button 1221 of the region setting portion 122 provided on the upper panel 1001a of the operation screen 1001. Accordingly, a file of the 2D map of the first region 3 is read, and the 2D map of the first region 3 is displayed as an image on the central panel 1001c. Subsequently, when the user selects a region selection tool 1222 of the region setting portion 122 provided on the upper panel 1001a, a setting screen of the second region 5 is displayed on the right panel 1001d, and a region can be selected on the map displayed on the central panel 1001c. In this example, a region name setting portion 1223 is displayed as the setting screen of the second region 5, and the user can select a range of the second region 5 by dragging the mouse on the central panel 1001c. The second region 5 can be selected at a plurality of locations on the map. For example, a “region A” and a “region B” can be selected as the second region 5 (see FIG. 9).

A touch panel type display may be adopted as the display provided in the input and output device 130. In this case, the range of the second region 5 may be selected by dragging, with a finger, on the central panel 1001c of the operation screen 1001 displayed on the display. Alternatively, the second region 5 may be selected by tapping vertices of a region on the central panel 1001c of the operation screen 1001 displayed on the touch panel type display. The second region 5 may be selected by a dedicated device such as a stylus pen.

After selecting the second region 5, the user inputs a region name to the region name setting portion 1223 and presses a save button 1224. That is, the user inputs the name of the selected second region 5 in a text box of the region name setting portion 1223 and presses the save button 1224. In a case where the second region 5 is set at a plurality of locations, the user inputs a name for identifying the selected second region 5 from the other second regions 5 to the region name setting portion 1223, and presses the save button 1224. Accordingly, the region information D2 including the name of the second region 5 is stored in the region setting storage unit 152. Conversely, the data stored in the region setting storage unit 152 is displayed by the region setting portion 122 of the right panel 1001d, for example.

FIG. 9 is a diagram illustrating a display screen of the operation mode setting portion according to Embodiment 1. The user sets an operation mode defining a determination method of at least one of the moving direction and the speed of the first mobile body 2 on the display screen of the operation mode setting portion 123. As an example, a method of changing settings of a “route following mode” in a list of operation modes displayed on the left panel 1001b of the operation screen 1001 will be described. First, a “route following mode” 1231 of the left panel 1001b is selected by tapping. By this selection, a pop-up menu is displayed, and “edit” 1232 is selected from the pop-up menu by tapping.

Accordingly, a setting portion for setting the operation mode is displayed on the right panel 1001d. For example, a plurality of setting portions 1232 to 1235 for setting the following content are displayed on the right panel 1001d. In the setting portions 1232 to 1235, for example, a name of an operation mode, a maximum moving speed when moving in the operation mode, whether to perform an operation of avoiding a human in the operation mode, and a safety stop timeout time in the operation mode (a standby time until the system issues an error warning to interrupt control of the first mobile body 2 in a case where the first mobile body 2 continues to stop in front of an obstacle) are set. The user appropriately inputs the setting content to the setting portions 1232 to 1235 and presses a save button 1236.

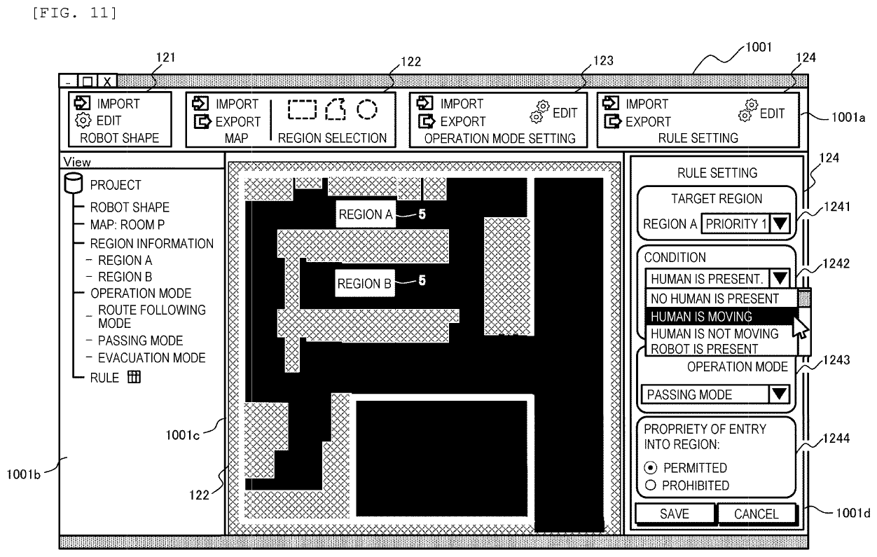

FIG. 10 is a diagram illustrating a display screen of the operation mode selection rule setting portion according to Embodiment 1. Hereinafter, in order to specifically describe a method of setting an operation mode selection rule, a case where the first mobile body 2 is controlled to perform an operation 1 and an operation 2 will be described.

Operation 1: When the second mobile body 4 enters the region A to perform work while the first mobile body 2 is moving inside the region A as the second region 5 or while the first mobile body 2 is stopped inside the region A, the first mobile body 2 quickly evacuates to the outside of the region A.

Operation 2: When the second mobile body 4 is present inside the region A while the first mobile body 2 is moving outside the region A, the first mobile body 2 is controlled not to enter the region A.

First, on the operation screen 1001 illustrated in FIG. 10, the user taps the second region 5 for which a rule is to be set, and selects “add rule” from a pop-up menu. In the example illustrated in FIG. 10, two regions of the “region A” and the “region B” are set as the second region 5, and the user taps and selects one of the “region A” and the “region B”. In the example illustrated in FIG. 10, the “region A” is selected. Accordingly, a pop-up menu is displayed, and the user taps and selects “add rule” from the pop-up menu. The operation mode selection rule setting portion 124 appears on the right panel 1001d of the operation screen 1001. As an example, the operation mode selection rule setting portion 124 displayed on the right panel 1001d includes a target second region display portion 1241, a condition setting portion 1242, a selected operation mode setting portion 1243, and an entry propriety setting portion 1244.

The target second region display portion 1241 is a GUI element that displays an identification name of the second region 5 to which the rule to be set is applied, and the “region A” is displayed in the example in FIG. 10.

The condition setting portion 1242 is a GUI element that sets a condition (detection condition) to be satisfied by the second mobile body detection information D6 acquired by the second mobile body detection unit 125. The condition setting portion 1242 illustrated in FIG. 10 is designed such that a detection condition can be selected from predetermined candidates by a pull-down box, and “presence of human” is selected as an example. A method for describing the condition may be a method for inputting a text that conforms to the grammar of a programming language or a dedicated format. When a plurality of detection conditions are desired to be used, the detection conditions are added by pressing a “+add” button 1245 of the condition setting portion 1242.

The selected operation mode setting portion 1243 is a GUI element for setting the information D3 of the operation mode to be selected by the first mobile body control unit 127 when the detection condition set by the condition setting portion 1242 is satisfied. In the selected operation mode setting portion 1243 illustrated in FIG. 10, an “evacuation mode” is selected by a pull-down box. Here, the “evacuation mode” is a predetermined operation mode in which the first mobile body 2 is controlled to move to the outside of the region A as the second region 5.

From the combination of the settings in the condition setting portion 1242 and the selected operation mode setting portion 1243, the operation mode selection rule for the “region A” that is the second region 5 illustrated in FIG. 10 is described as follows. By a rule that “when a human is present inside the region A and the first mobile body 2 is present inside the region A, the first mobile body 2 is controlled by the ‘evacuation mode’”, the above “operation 1” is achieved.

The description returns to the GUI elements again. The entry propriety setting portion 1244 is a GUI element for setting whether to permit entry into the “region A” of the second region 5 that is a rule setting target when the first mobile body 2 is present outside the “region A” that is the rule setting target and the detection condition set by the condition setting portion 1242 is satisfied. In the entry propriety setting portion 1244 illustrated in FIG. 10, the entry into the “region A” is set to “prohibited”.

As described above, the operation mode selection rule for the “region A” illustrated in FIG. 10 is described as follows from the combination of the settings in the condition setting portion 1242 and the entry propriety setting portion 1244. By a rule that “when a human is present inside the region A and the first mobile body 2 is present outside the region A, control is performed so that the first mobile body 2 does not enter the region A, and the operation mode at that time is determined according to an operation mode selection rule set for the region where the first mobile body 2 is present,” the above operation 2 is achieved.

As described above, the operation 1 and the operation 2 can be implemented by a combination of settings of the condition setting portion 1242, the selected operation mode setting portion 1243, and the entry propriety setting portion 1244. Accordingly, when the second mobile body 4 is present in the “region A”, the first mobile body 2 can be operated so as not to interfere with the work of the second mobile body 4 working in the “region A”. On the other hand, when the second mobile body 4 is not present in the “region A” that is the second region, the first mobile body 2 can smoothly pass through the “region A” without switching the operation mode, and thus both the work efficiency of the second mobile body 4 and the movement efficiency of the first mobile body 2 can be improved.

### Embodiment 2

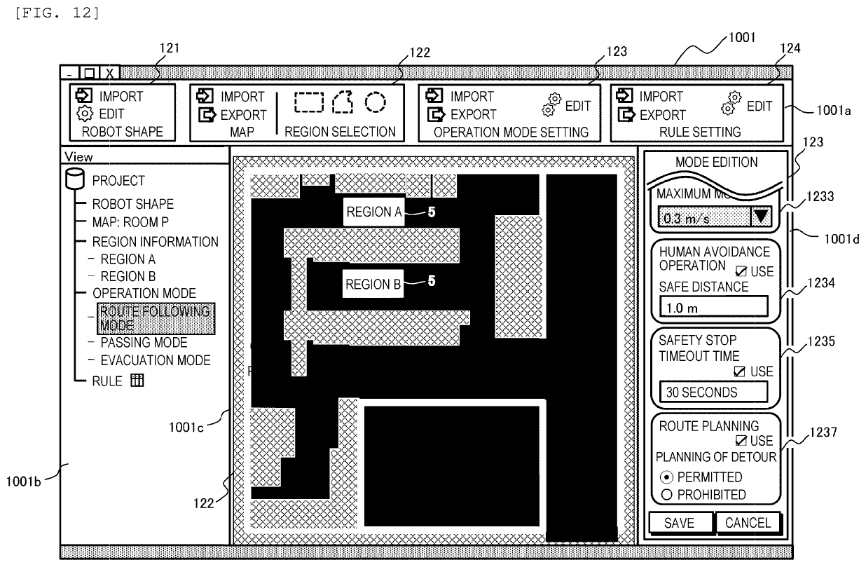

FIG. 11 is a diagram illustrating an operation screen of an operation mode selection rule setting portion according to Embodiment 2.

Embodiment 2 is a modification of the condition setting portion 1242 constituting the operation mode selection rule setting portion 124. In Embodiment 1, when the second mobile body 4 is present in the “region A” that is the second region 5, the operation mode selection rule is set such that the first mobile body 2 does not enter the corresponding second region 5, and the first mobile body 2 does not hinder the work of the second mobile body 4.

However, according to this method, in a case where although the second mobile body 4 is present inside the second region 5 for which the operation mode selection rule is set, the second mobile body 4 does not perform work and is only moving taking the second region 5 as a passage, the first mobile body 2 cannot enter the second region 5 until the second mobile body 4 exits from the second region 5, causing a problem that the movement efficiency is poor.

Therefore, in Embodiment 2, in order to solve such a problem, “whether the second mobile body present inside the second region is moving (passing)” is added to conditions that can be selected in the condition setting portion 1242. As described above, it is preferable that a candidate for the detection condition set by the condition setting portion 1242 includes that at least a part of the second mobile body 4 as a human is present inside the second region 5 and the second mobile body 4 is moving. Accordingly, the operation mode selection rule subjected to case classification as follows can be set, and the movement efficiency of the first mobile body 2 can be improved.
When the second mobile body 4 is present inside the second region 5 and the second mobile body 4 is not moving (that is, when the second mobile body 4 is working), entry of the first mobile body 2 into the second region 5 is prohibited.
When the second mobile body 4 is present inside the second region 5 and the second mobile body 4 is moving (that is, when the second mobile body 4 is not working), entry of the first mobile body 2 into the second region 5 is permitted.

As a method of determining whether the second mobile body 4 is moving, for example, there is a method of detecting the position and speed of the second mobile body 4 by the second mobile body detection device 10, determining that the second mobile body 4 is moving when a magnitude of the speed of the second mobile body 4 is equal to or greater than a threshold, and determining that the second mobile body 4 is not moving when the magnitude of the speed of the second mobile body 4 is less than the threshold.

When the second mobile body 4 is a human, the second mobile body detection device 10 may acquire image data of the second mobile body 4 and estimate, by image processing, whether the second mobile body 4 is moving. As a method of recognizing the operation of the second mobile body 4 by image processing, there are a method of directly inferring content of the operation by machine learning, and a method of performing determination based on a feature such as a line of sight, an orientation of the face, an orientation of the body, or an angle of a foot of the worker who is the second mobile body 4.

Here, when the worker who is the second mobile body 4 frequently changes the position inside the second region 5 in order to perform work, in the method of comparing the magnitude of the moving speed of the second mobile body 4 with the threshold as described above or the method of estimating the operation content of the worker from an image, there is a possibility that the worker who is performing the work is erroneously detected as moving.

In such a case, a method of comparing an angle formed by a moving direction of the second mobile body 4 and a passing direction of the first mobile body 2 set with respect to the second region 5 with a threshold is effective for reducing an erroneous detection rate. More specifically, it is preferable to determine, on the condition that the angle formed by the moving direction of the second mobile body 4 and the passing direction of the first mobile body 2 is larger than the threshold, that the second mobile body 4 is working. In other words, it is preferable that the candidate for the detection condition set by the condition setting portion 1242 includes that at least a part of the second mobile body 4 as a human is present inside the second region 5 and the moving direction of the second mobile body is outside a predetermined range with respect to the moving direction of the first mobile body 2. Accordingly, it is possible to reduce erroneous determination of whether the second mobile body 4 is working.

As described above, when the first mobile body 2 and the second mobile body 4 pass each other in the second region 5 that is a relatively narrow region, the first mobile body 2 and the second mobile body 4 often relatively approach each other while moving in the midst of passing each other. Therefore, a safety function of the first mobile body 2 is activated, and unintended stop of the first mobile body 2 is likely to occur.

Therefore, it is preferable that the operation mode used when the first mobile body 2 enters the second region 5 where the second mobile body 4 is present is set such that a maximum speed of a maximum moving speed setting portion 1233 is a low safe speed. In a human avoidance operation setting portion 1234, it is preferable to set a safe distance to be small enough to implement the passing each other. Accordingly, the above-described unintended stop can be prevented. Such flexible setting is also beneficial to the mobile body control system 1 according to the embodiment.

### Embodiment 3

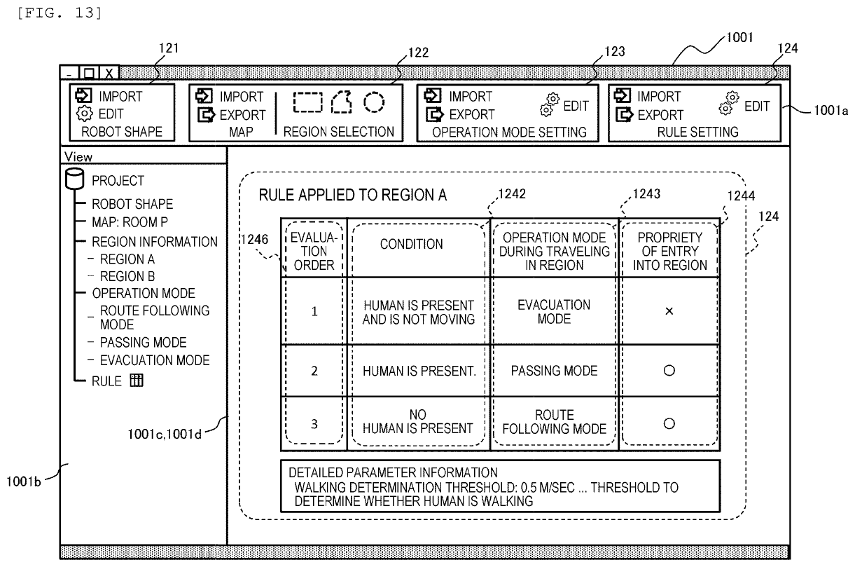

FIG. 12 is a diagram illustrating a display screen of an operation mode setting portion according to Embodiment 3.

Embodiment 3 is a modification of the operation mode setting portion 123. In addition to the setting portions 1232 to 1235 described in Embodiment 1, the operation mode setting portion 123 of Embodiment 3 includes a detour planning function setting portion 1237 for setting whether to permit planning of a detour that is a route for detouring the first mobile body 2 when an obstacle is detected during operation.

As illustrated in FIG. 12, when an obstacle is detected in a state where the planning of the detour is permitted in the detour planning function setting portion 1237, the first mobile body control unit 127 automatically plans a detour, and the first mobile body 2 moves along the detour. In other words, the first mobile body control unit 127 executes the planning of the detour and a detour operation when the planning of the detour is permitted in the selected operation mode and the second mobile body 4 is detected by the second mobile body detection unit 125. However, the automatically planned detour may not necessarily be desirable for the second mobile body 4 that is a human. On the other hand, according to the embodiment, for example, the planning of the detour can be invalidated depending on the state of the second mobile body 4, and the first mobile body 2 can be controlled more appropriately.

When an obstacle is detected in a state where the planning of the detour is not permitted in the detour planning function setting portion 1237, the first mobile body 2 stands by until the obstacle disappears, and then resumes the movement when the obstacle is no longer detected.

### Embodiment 4

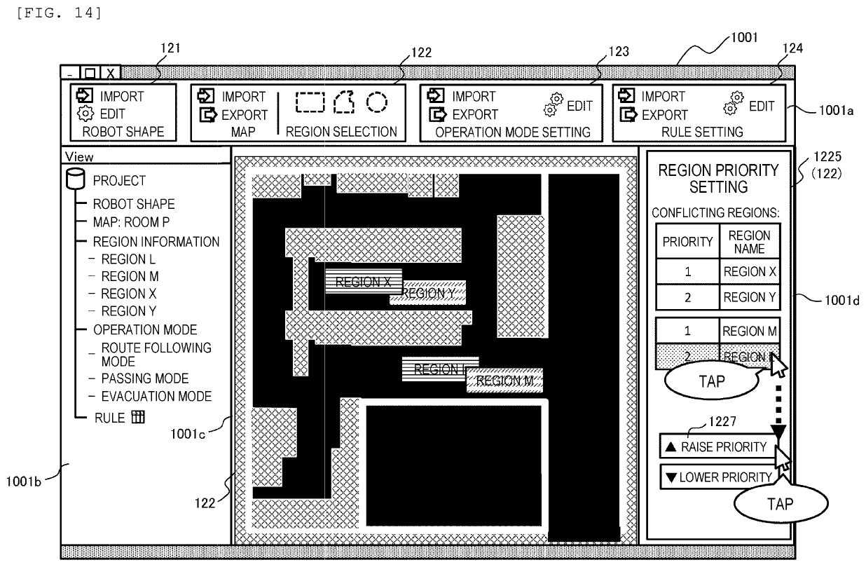

FIG. 13 illustrates a display screen of an operation mode selection rule setting portion according to Embodiment 4. As illustrated in FIG. 13, in the embodiment, a condition evaluation order setting portion 1246 for setting an order of evaluating a condition portion (setting content of the condition setting portion 1242) of an operation mode selection rule is added to the operation mode selection rule setting portion 124 of Embodiment 1.

In the example in FIG. 13, the central panel 1001c and the right panel 1001d of the operation screen 1001 show, in an evaluation order set in the condition evaluation order setting portion 1246, a list of setting content of the condition setting portion 1242, the selected operation mode setting portion 1243, and the entry propriety setting portion 1244 that constitute the operation mode selection rule setting portion 124.

As a background of the embodiment, when a plurality of operation mode selection rules are set for the same second region 5, setting content of the condition setting portion 1242 for the operation mode selection rules may not necessarily be contradictory conditions.

Therefore, in the embodiment, the order of evaluating the condition portions of the operation modes can be set by the condition evaluation order setting portion 1246. The first mobile body control unit 127 evaluates the plurality of operation mode selection rules according to the evaluation order of the condition portion, and first selects an operation mode in which the condition is satisfied.

Accordingly, it is possible to prevent the occurrence of a problem that an unintended operation mode is selected by the first mobile body control unit 127 due to a conflict between the plurality of operation mode selection rules.

### Embodiment 5

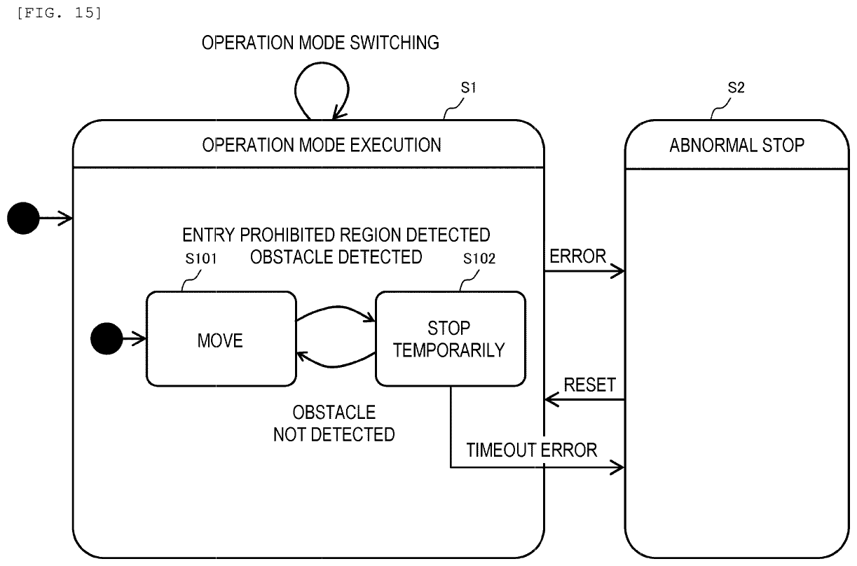

FIG. 14 is a diagram illustrating an example of a display screen of a region setting portion according to Embodiment 5.
As illustrated in FIG. 14, the embodiment is an example in which a second region priority setting portion 1225 is added to the region setting portion 122 of Embodiment 1. In the second region priority setting portion 1225, priorities of the second regions 5 set at a plurality of locations are set. When at least a part of the first mobile body 2 is simultaneously present inside a plurality of second regions 5, the first mobile body control unit 127 selects an operation mode based on an operation mode selection rule set for the second region 5 having a highest priority.

As a background of the embodiment, when a plurality of second regions 5 are set inside the first region 3, at least a part of the first mobile body 2 may be simultaneously present inside a plurality of the second regions 5. In other words, a part or the whole of the first mobile body 2 may be simultaneously present inside a plurality of the second regions 5.

For example, in the example illustrated in FIG. 14, a part of a “region X” and a part of a “region Y” overlap each other, and a part of a “region M” and a part of a “region L” overlap each other. Therefore, at least a part of the first mobile body 2 may be simultaneously present inside the “region X” and the “region Y”, or may be simultaneously present inside the “region M” and the “region L”.

Therefore, in the embodiment, the second region priority setting portion 1225 is added to the region setting portion 122, and the priorities of the regions for evaluating the operation mode selection rule can be set. In the example illustrated in FIG. 14, in a condition evaluation order of “region X” and “region Y”, the “region X” is set to priority 1 and the “region Y” is set to priority 2, and in a condition evaluation order of “region M” and “region L”, the “region M” is set to priority 1 and the “region L” is set to priority 2.

The first mobile body control unit 127 evaluates operation mode selection rules of the plurality of regions according to the region priority, and applies the operation mode selection rule of the region in which the condition is first satisfied. The first mobile body control unit 127 first extracts a plurality of second regions 5 in which a part or the whole of the first mobile body 2 is present, selects the second region 5 having the highest priority, and then evaluates a condition portion of the operation mode selection rule set for the second region 5. If the evaluated operation mode selection rule satisfies the condition, the corresponding operation mode is selected. When the evaluated operation mode selection rule does not satisfy the condition, the first mobile body control unit 127 selects the second region 5 having the next highest priority and evaluates the condition portion of the operation mode selection rule set for the second region 5.

Accordingly, it is possible to prevent the occurrence of a problem that an unintended operation mode is selected by the first mobile body control unit 127 due to a conflict between the operation mode selection rules associated with the plurality of second regions 5.

When the user wants to change the priorities of the regions, for example, when the user wants to raise the priority of the “region L”, the user taps and selects the region name “region L” in the second region priority setting portion 1225 and taps and selects a “raise priority” button 1227. Accordingly, the priority of the “region L” is changed from priority 2 to priority 1, and the priority of the “region M” is changed from priority 1 to priority 2.

### Embodiment 6

FIG. 15 is a state transition diagram of a first mobile body control unit according to Embodiment 6. The embodiment is an example in which the mobile body control system 1 includes an obstacle detection device configured to detect an obstacle that obstructs the movement of the first mobile body 2, and the first mobile body control unit 127 is managed by a state machine for the purpose of preventing interference with the obstacle. In the embodiment, the second mobile body detection device 10 also functions as an obstacle detection device. Of course, the obstacle detection device may be provided separately from the second mobile body detection device 10.

As illustrated in FIG. 15, the first mobile body control unit 127 is in an operation mode execution state S1 during the operation of the first mobile body 2, and immediately ends control over the first mobile body 2 and transitions to an abnormal stop state S2 when detecting any error inside. For example, when the passage of the first mobile body 2 is hindered by an unexpected obstacle, the first mobile body control unit 127 also transitions from the operation mode execution state S1 to the abnormal stop state S2. Thereafter, in order to return the first mobile body control unit 127 from the abnormal stop state S2 to the operation mode execution state S1, a user needs to perform a reset operation.

In the embodiment, the first mobile body control unit 127 in the operation mode execution state S1 makes a state transition between a moving state S101 and a temporary stop state S102 according to a result of detection/non-detection of an obstacle by the obstacle detection device. The “moving state” is a state where the first mobile body control unit 127 is performing control of moving the first mobile body 2. The “temporary stop state” is a state where the first mobile body control unit 127 suspends the control of moving the first mobile body 2 and temporarily stops the first mobile body 2 for safety.

When the first mobile body 2 is moving, the first mobile body control unit 127 is in the moving state S101 (operation mode execution state S1). In this state, when an obstacle is detected by the obstacle detection device, the first mobile body control unit 127 transitions to the primary stop state S102 (operation mode execution state S1). Thereafter, when the obstacle is no longer detected by the obstacle detection device within a certain period of time (when the obstacle is not detected), the first mobile body control unit 127 transitions from the primary stop state S102 to the moving state S101, and the control over the first mobile body 2 is resumed.

On the other hand, when the temporary stop state S102 continues for a certain time, the first mobile body control unit 127 issues a timeout error and transitions from the primary stop state S102 to the abnormal stop state S2. That is, when the primary stop state S102 continues for a certain time or more, the first mobile body control unit 127 transitions from the operation mode execution state S1 to the abnormal stop state S2.

As described above, when the first mobile body control unit 127 is in the operation mode execution state S1, the first mobile body control unit 127 transitions between the moving state S101 and the primary stop state S102, so that unnecessary transition of the first mobile body control unit 127 from the operation mode execution state S1 to the abnormal stop state S2 can be restricted. Accordingly, it is possible to save the trouble of a reset operation or the like for the user.

The condition for the first mobile body control unit 127 to make a state transition from the moving state S101 to the temporary stop state S102 is not limited to detection of an obstacle. For example, when an entry prohibited region is detected on a path of the first mobile body 2, the first mobile body control unit 127 may perform the state transition from the moving state S101 to the temporary stop state S102.

### Embodiment 7

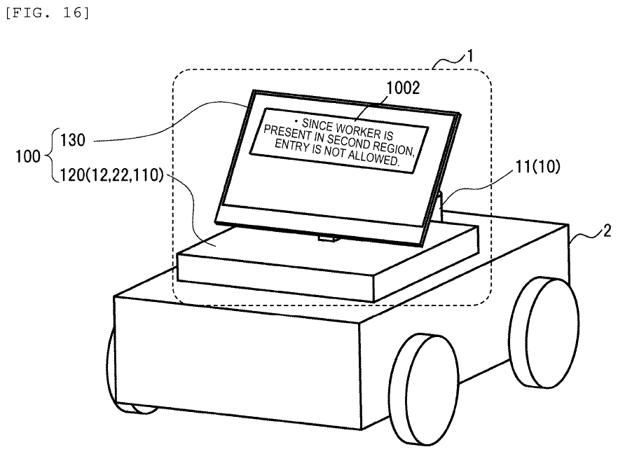

FIG. 16 is a diagram illustrating a mobile body control system according to Embodiment 7. The mobile body control system 1 according to Embodiment 7 is an example in which a movement information display portion configured to display information regarding movement of the first mobile body 2 is provided in addition to the configuration according to Embodiment 6. As an example, as illustrated in FIG. 16, the mobile body control system 1 includes a movement information display portion 1002 configured to display information regarding movement of the first mobile body 2 as one of display screens of the input and output device 130 (display) mounted on the first mobile body 2. In other words, the mobile body control system 1 according to the embodiment includes the input and output device 130 (display) that functions as the movement information display portion 1002. As an example, the first mobile body control unit 127 causes the movement information display portion 1002 of the input and output device 130 (display) to display information regarding the movement of the first mobile body 2 as necessary.

In the embodiment, when the state transition from the moving state S101 to the temporary stop state S102 is performed before the second region 5 into which the entry is prohibited, the first mobile body control unit 127 causes the movement information display portion 1002 to display information indicating that entry into the second region 5 is not allowed since the second mobile body 4 is present in the second region 5. That is, the first mobile body control unit 127 causes the movement information display portion 1002 to display, to the second mobile body 4 present inside the second region 5, the reason of being in the temporary stop state S102. For example, as illustrated in FIG. 16, the first mobile body control unit 127 displays information, which reads “since worker is present in second region, entry is not allowed,” on the movement information display portion 1002 of the input and output device 130.

Further, the first mobile body control unit 127 may cause the movement information display portion 1002 to display, to the second mobile body 4, information such as a time required for the first mobile body 2 to pass through the second region 5, in which the second mobile body 4 is present, when the first mobile body 2 resumes moving.

According to the embodiment, for example, when a worker that is the second mobile body 4 blocks the passage of the first mobile body 2 and the first mobile body 2 can pass through the second region 5 in a relatively short time, the worker can be prompted to gives way to the first mobile body 2, and an effect of improving the movement efficiency of the first mobile body 2 can be achieved.

### Embodiment 8

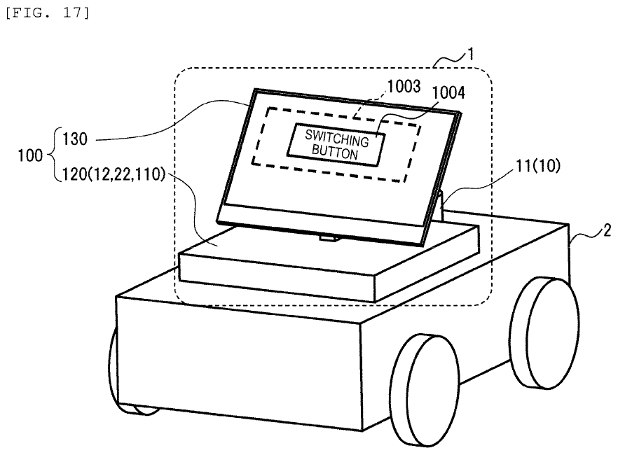

FIG. 17 is a diagram illustrating a mobile body control system according to Embodiment 8. The mobile body control system 1 according to Embodiment 8 is an example in which an operation mode switching operation portion 1003 is added to the mobile body control system 1 according to Embodiment 6.

As illustrated in FIG. 17, the mobile body control system 1 includes the operation mode switching operation portion 1003 for switching an operation mode of the first mobile body control unit 127 by a manual operation of a user, as one of display screens of the input and output device 130 (display) mounted on the first mobile body 2. In other words, the mobile body control system 1 according to the embodiment includes the input and output device (display) 130 that functions as the operation mode switching operation portion 1003.

In this example, a display constituting the input and output device 130 is a touch panel type display. The operation mode switching operation portion 1003 may include, for example, a button switch or the like provided on the first mobile body 2.

For example, before the second region 5 into which the entry of the first mobile body 2 is prohibited, when the first mobile body control unit 127 performs a state transition from the moving state S101 to the temporary stop state S102, as illustrated in FIG. 17, a switching button 1004 as the operation mode switching operation portion 1003 is displayed on the input and output device (display) 130. When a worker presses the switching button 1004 as necessary, the first mobile body control unit 127 performs a state transition from the temporary stop state S102 to the moving state S101, and the control over the first mobile body 2 is forcibly resumed.

In this example, although the first mobile body control unit 127 performs the state transition from the temporary stop state S102 to the moving state S101 by the worker pressing the switching button 1004, for example, a plurality of types of switching buttons 1004 may be displayed, and the first mobile body 2 may be controlled in a predetermined operation mode according to the switching button 1004 selected by the user (worker).

According to a mobile body control device 1 of the embodiment, an operation of passing between the first mobile body 2 and the worker as the second mobile body 4, an evacuation operation of the first mobile body 2, and the like are executed early. For example, when the first mobile body 2 obstructs the passage of the second mobile body 4 that is the worker, the worker as the second mobile body 4 can move a position of the first mobile body 2.

### Embodiment 9

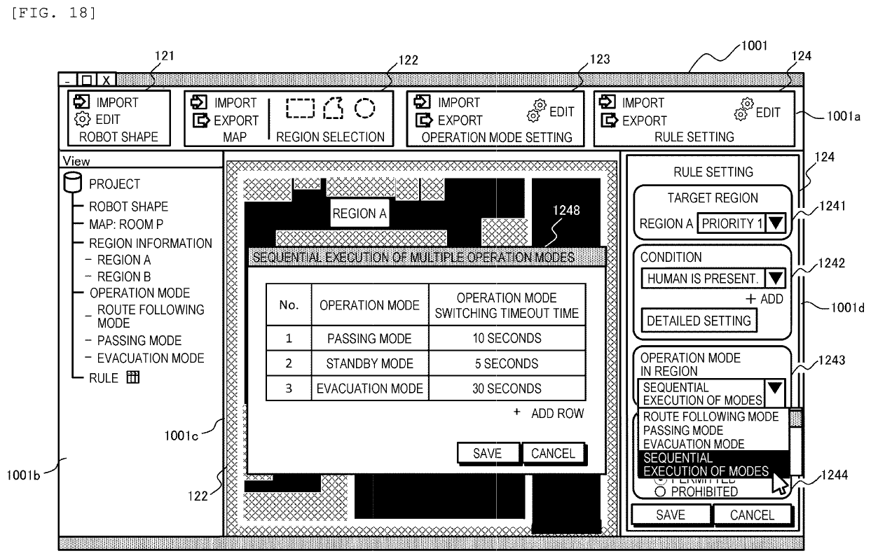

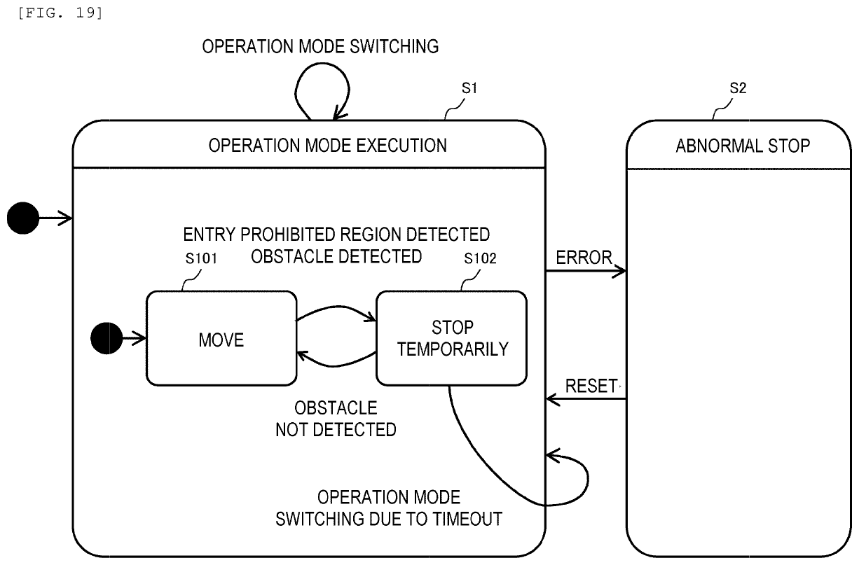

FIG. 18 is a diagram illustrating a display screen of an operation mode selection rule setting portion according to Embodiment 9, and FIG. 19 is a diagram illustrating a state transition of a mobile body control system according to Embodiment 9.

The embodiment is an example in which a multiple operation mode setting portion 1248 configured to set a plurality of operation modes is added to the operation mode selection rule setting portion 124 of Embodiment 1. In this example, as illustrated in FIG. 18, the multiple operation mode setting portion 1248 is displayed on the central panel 1001c of the operation screen 1001 so as to be superimposed on the region setting portion 122.

When a specific condition is satisfied in the corresponding second region 5 (for example, the second region 5 selected in advance by a user), the plurality of operation modes to be sequentially executed are set in the multiple operation mode setting portion 1248. Then, the first mobile body control unit 127 performs trial run of the plurality of operation modes sequentially according to the operation mode selection rule information D4. As an example, the first mobile body control unit 127 sequentially executes a plurality of operation modes in the order of a “passing mode”, a “standby mode”, and an “evacuation mode”.

More specifically, in the multiple operation mode setting portion 1248, the order, in which the plurality of operation modes are tried, and a timeout time until the next operation mode is switched when the first mobile body 2 cannot move even if an operation mode is selected are set. Accordingly, for the second region 5 in which an error stop is likely to occur, an operation mode that allows passage through the corresponding second region 5 without an error stop can be selected to be tried.

For example, as illustrated in FIG. 19, in the embodiment, when the temporary stop state S102 continues for a certain time, differently from the case of Embodiment 6 (see FIG. 16), the first mobile body control unit 127 merely switches the operation mode, and does not immediately transition to the abnormal stop state S2.

In the example illustrated in FIG. 18, when the second mobile body 4 enters the “region A” that is the second region 5 while the first mobile body 2 is moving in the corresponding region A, first, the “passing mode” is selected, and passing each other between the first mobile body 2 and the second mobile body 4 is tried. When the first mobile body 2 and the second mobile body 4 cannot pass each other and 10 seconds elapses, the operation mode transitions from the “passing mode” to the “standby mode”. In the “standby mode”, the first mobile body 2 stands by on the spot for 5 seconds. “standby mode” to the “evacuation mode”, and evacuation to the outside of the “region A” is tried. When the evacuation to the outside of the “region A” is tried but the first mobile body 2 cannot be moved, the movement control is interrupted due to a timeout error after 30 seconds of the trial. That is, the first mobile body control unit 127 transitions from the operation mode execution state S1 to the abnormal stop state S2.

In this way, by enabling setting of a plurality of operation modes, the first mobile body 2 can be controlled more appropriately. In general, a mobile robot that travels in a narrow region cannot plan an appropriate route and is likely to stop due to an error stop. However, in the embodiment, by trying moving while switching the operation mode, it is possible to implement an action that is less likely to cause an error stop.

### Appendix

### (Appendix 1)

A mobile body control system for controlling a mobile body that moves in at least one region, the mobile body control system including:
a first mobile body setting portion configured to set shape information of a first mobile body based on an operation of a user;
a region setting portion configured to display a first region that is a region in which the first mobile body moves and a second region that is a closed region inside the first region, and set the first region and the second region based on an operation of the user;
a second mobile body detection unit configured to acquire detection information regarding presence or absence and a state of a second mobile body present in the second region;
an operation mode setting portion configured to display information on an operation mode defining a determination method of at least one of a moving direction and a speed when the first mobile body moves in the first region, and set the operation mode based on an operation of the user;
an operation mode selection rule setting portion configured to display an operation mode selection rule that is information on a rule for selecting the operation mode according to the detection information of the second region, and set the operation mode selection rule according to an operation of the user;
a setting information storage unit configured to store the shape information of the first mobile body and setting information of the first region, the second region, the operation mode, and the operation mode selection rule;
a first mobile body position estimation unit configured to estimate and output position information of the first mobile body in the first region; and
a first mobile body control unit configured to select the operation mode according to the setting information stored in the setting information storage unit and perform operation planning and control of the first mobile body.

### (Appendix 2)

The mobile body control system according to appendix 1, in which
the operation mode selection rule setting portion includes
a condition setting portion configured to set a detection condition related to the detection information, and
a selected operation mode setting portion configured to set the operation mode selected by the first mobile body control unit when the detection condition is satisfied.

### (Appendix 3)

The mobile body control system according to appendix 2, in which
the operation mode selection rule setting portion includes an entry propriety setting portion configured to set whether the first mobile body present outside the second region enters the second region when the detection condition is satisfied, and
the first mobile body control unit controls the first mobile body according to setting content of the entry propriety setting portion.

### (Appendix 4)

The mobile body control system according to appendix 2 or 3, in which
the operation mode selectable by the first mobile body control unit includes an evacuation mode of moving the first mobile body in the second region to an outside of the second region.

### (Appendix 5)

The mobile body control system according to any one of appendixes 2 to 4, in which
a candidate for the detection condition includes that at least a part of the second mobile body is present inside the second region.

### (Appendix 6)

The mobile body control system according to any one of appendixes 2 to 5, in which
a candidate for the detection condition includes that at least a part of the second mobile body is present inside the second region and a moving speed of the second mobile body is equal to or less than a predetermined threshold.

### (Appendix 7)

The mobile body control system according to any one of
a candidate for the detection condition includes that at least a part of the second mobile body as a human is present inside the second region.

### (Appendix 8)

The mobile body control system according to any one of appendixes 2 to 7, in which
a candidate for the detection condition includes that at least a part of the second mobile body as a human is present inside the second region and a moving direction of the second mobile body is outside a predetermined range with respect to the moving direction of the first mobile body.

### (Appendix 9)

The mobile body control system according to any one of appendixes 1 to 8, in which
the operation mode setting portion includes a detour planning function setting portion configured to set whether to permit planning of a detour that is a route for detouring the first mobile body when the second mobile body is present on a path of the first mobile body, and
the first mobile body control unit executes the planning of the detour and a detour operation when the planning of the detour is permitted in the selected operation mode and the second mobile body is detected by the second mobile body

### (Appendix 10)

The mobile body control system according to any one of appendixes 2 to 8, in which
the region setting portion includes a condition evaluation order setting portion configured to set an evaluation order for the plurality of detection conditions related to the state of the second mobile body that are set for one of a plurality of the second regions, and
when the first mobile body is present inside the second region, the first mobile body control unit evaluates the plurality of detection conditions set for the second region according to the evaluation order and selects the operation mode corresponding to the detection condition first satisfied.

### (Appendix 11)

The mobile body control system according to any one of appendixes 1 to 10, in which
the operation mode selection rule setting portion includes a second region priority setting portion configured to set priorities of the second regions set at a plurality of locations, and
when at least a part of the first mobile body is simultaneously present inside the plurality of second regions, the first mobile body control unit selects the operation mode based on the operation mode selection rule set for the second region having a highest priority.

### (Appendix 12)

The mobile body control system according to any one of appendixes 1 to 11, in which
the first mobile body control unit includes a state machine that takes any one state of an operation mode execution state and an abnormal stop state,
the state machine transitions from the operation mode execution state to the abnormal stop state when an internal error occurs,
the state machine in the operation mode execution state further has internal states of a moving state and a temporary stop state, and
the state machine
   transitions from the moving state to the temporary stop state when an obstacle or an entry prohibited region is detected on a path of the first mobile body,
   transitions from the temporary stop state to the moving state when the obstacle and the entry prohibited region are no longer detected, and
   issues a timeout error and transitions to the abnormal stop state when the temporary stop state continues for a certain time.

### (Appendix 13)

The mobile body control system according to appendix 12, including:
a movement information display portion configured to display, for the second mobile body present inside the second region, a reason for the temporary stop state when the first mobile body control unit is in the temporary stop state before the second region, or display a time required for passage in the second region when the first mobile body resumes moving.

### (Appendix 14)

The mobile body control system according to appendix 12 or 13, including:
an operation mode switching operation portion configured to receive an operation of a user and switch the operation mode when the first mobile body control unit is in the temporary stop state, in which
the first mobile body control unit receives input to the operation mode switching operation portion, ends the temporary stop state, and controls the first mobile body in the operation mode designated by the user.

### (Appendix 15)

The mobile body control system according to any one of appendixes 1 to 14, in which
the operation mode selection rule setting portion includes a multiple operation mode setting portion configured to set the plurality of operation modes, which are assigned with an order, and a timeout time in a case where each operation mode is in a temporary stop state, and
when a condition set in n the multiple operation mode setting portion is satisfied, the first mobile body control unit selects the corresponding operation mode in the order set by the multiple operation mode setting portion, and when the operation mode has a timeout in the temporary stop state, the first mobile body control unit switches to the next operation mode.

### (Appendix 16)

A mobile body control system for controlling a first mobile body that moves in a first region, the mobile body control system including:
a region setting portion configured to set a second region that is a closed region inside the first region;
a second mobile body detection unit configured to detect a state of a second mobile body present in the second region;
an operation mode setting portion configured to set, by an operation of a user, content of an operation mode defining a movement condition when the first mobile body moves in the first region; and
a first mobile body control unit configured to select the operation mode based on a detection result of the second mobile body detection unit and control the first mobile body based on the selected operation mode.

### (Appendix 17)

The mobile body control system according to appendix 16, further including:
an operation mode selection rule setting portion configured to set an operation mode selection rule, which is a rule when the operation mode is selected by the first mobile body control unit, by an operation of the user.

### REFERENCE SIGNS LIST

1: mobile body control system
2: first mobile body
3: first region
4: second mobile body
5: second region
10: second mobile body detection device
11: second mobile body detection sensor
12: signal processing module
20: first mobile body position estimation device
21: first mobile body position estimation sensor
22: signal processing module
100: setting device
110: control device
121: first mobile body setting portion
122: region setting portion
1225: second region priority setting portion
123: operation mode setting portion
1237: detour planning function setting portion
124: operation mode selection rule setting portion
1242: condition setting portion
1243: selected operation mode setting portion
1244: entry propriety setting portion
1246: condition evaluation order setting portion
1248: multiple operation mode setting portion
125: second mobile body detection unit
126: first mobile body position estimation unit
127: first mobile body control unit
130: input and output device
150: setting information storage unit
151: first mobile body setting storage unit
152: region setting storage unit
153: operation mode setting storage unit
154: operation mode selection rule setting storage unit
1001: operation screen (user interface)
1001a: upper panel
1001b: left panel
1001c: central panel
1001d: right panel
1002: movement information display portion
1003: operation mode switching operation portion
D1: shape information of first mobile body
D2: region information
D3: operation mode information
D4: operation mode selection rule information
D5: first mobile body position information
D6: second mobile body detection information

1. A mobile body control system for controlling a mobile body that moves in at least one region, the mobile body control system comprising:
a first mobile body setting portion configured to set shape information of a first mobile body based on an operation of a user;
a region setting portion configured to display a first region that is a region in which the first mobile body moves and a second region that is a closed region inside the first region, and set the first region and the second region based on an operation of the user;
a second mobile body detection unit configured to acquire detection information regarding presence or absence and an operation of a second mobile body present in the second region;
an operation mode setting portion configured to display information on an operation mode defining a determination method of at least one of a moving direction and a speed when the first mobile body moves in the first region, and set the operation mode based on an operation of the user;
an operation mode selection rule setting portion configured to display an operation mode selection rule that is information on a rule for selecting the operation mode according to the presence or absence and an operation of the second mobile body determined based on the detection information of the second region, and set the operation mode selection rule according to an operation of the user;
a setting information storage unit configured to store the shape information of the first mobile body and setting information of the first region, the second region, the operation mode, and the operation mode selection rule;
a first mobile body position estimation unit configured to estimate and output position information of the first mobile body in the first region; and
a first mobile body control unit configured to select the operation mode according to the setting information stored in the setting information storage unit and perform operation planning and control of the first mobile body.

2. The mobile body control system according to claim 1, wherein
the operation mode selection rule setting portion includes
a condition setting portion configured to set a detection condition related to the detection information, and
a selected operation mode setting portion configured to set the operation mode selected by the first mobile body control unit when the detection condition is satisfied.

3. The mobile body control system according to claim 2, wherein
the operation mode selection rule setting portion includes an entry propriety setting portion configured to set whether the first mobile body present outside the second region enters the second region when the detection condition is satisfied, and
the first mobile body control unit controls the first mobile body according to setting content of the entry propriety setting portion.

4. The mobile body control system according to claim 3, wherein
the operation mode selectable by the first mobile body control unit includes an evacuation mode of moving the first mobile body in the second region to an outside of the second region.

5. The mobile body control system according to claim 2, wherein
a candidate for the detection condition includes that at least a part of the second mobile body is present inside the second region.

6. The mobile body control system according to claim 2, wherein
a candidate for the detection condition includes that at least a part of the second mobile body is present inside the second region and a moving speed of the second mobile body is equal to or less than a predetermined threshold.

7. The mobile body control system according to claim 2, wherein
a candidate for the detection condition includes that at least a part of the second mobile body as a human is present inside the second region.

8. The mobile body control system according to claim 2, wherein
a candidate for the detection condition includes that at least a part of the second mobile body as a human is present inside the second region and a moving direction of the second mobile body is outside a predetermined range with respect to the moving direction of the first mobile body.

9. The mobile body control system according to claim 1, wherein
the operation mode setting portion includes a detour planning function setting portion configured to set whether to permit planning of a detour that is a route for detouring the first mobile body when the second mobile body is present on a path of the first mobile body, and
the first mobile body control unit executes the planning of the detour and a detour operation when the planning of the detour is permitted in the selected operation mode and the second mobile body is detected by the second mobile body detection unit.

10. The mobile body control system according to claim 2, wherein
the region setting portion includes a condition evaluation order setting portion configured to set an evaluation order for the plurality of detection conditions related to the operation of the second mobile body that are set for one of a plurality of the second regions, and
when the first mobile body is present inside the second region, the first mobile body control unit evaluates the plurality of detection conditions set for the second region according to the evaluation order and selects the operation mode corresponding to the detection condition first satisfied.

11. The mobile body control system according to claim 1, wherein
the operation mode selection rule setting portion includes a second region priority setting portion configured to set priorities of the second regions set at a plurality of locations, and
when at least a part of the first mobile body is simultaneously present inside the plurality of second regions, the first mobile body control unit selects the operation mode based on the operation mode selection rule set for the second region having a highest priority.

12. The mobile body control system according to claim 1, wherein
the first mobile body control unit includes a state machine that takes any one state of an operation mode execution state and an abnormal stop state,
the state machine transitions from the operation mode execution state to the abnormal stop state when an internal error occurs,
the state machine in the operation mode execution state further has internal states of a moving state and a temporary stop state, and
the state machine
transitions from the moving state to the temporary stop state when an obstacle or an entry prohibited region is detected on a path of the first mobile body,
transitions from the temporary stop state to the moving state when the obstacle and the entry prohibited region are no longer detected, and
issues a timeout error and transitions to the abnormal stop state when the temporary stop state continues for a certain time.

13. The mobile body control system according to claim 12, comprising:
a movement information display portion configured to display, for the second mobile body present inside the second region, a reason for the temporary stop state when the first mobile body control unit is in the temporary stop state before the second region, or display a time required for passage in the second region when the first mobile body resumes moving.

14. The mobile body control system according to claim 12, comprising:
an operation mode switching operation portion configured to receive an operation of a user and switching the operation mode when the first mobile body control unit is in the temporary stop state, wherein
the first mobile body control unit receives input to the operation mode switching operation portion, ends the temporary stop state, and controls the first mobile body in the operation mode designated by the user.

15. The mobile body control system according to claim 1, wherein
the operation mode selection rule setting portion includes a multiple operation mode setting portion configured to set the plurality of operation modes, which are assigned with an order, and a timeout time in a case where each operation mode is in a temporary stop state, and
when a condition set in the multiple operation mode setting portion is satisfied, the first mobile body control unit selects the corresponding operation mode in the order set by the multiple operation mode setting portion, and when the operation mode has a timeout in the temporary stop state, the first mobile body control unit switches to the next operation mode.

16. A mobile body control system for controlling a first mobile body that moves in a first region, the mobile body control system comprising:
a region setting portion configured to set a second region that is a closed region inside the first region;
a second mobile body detection unit configured to detect an operation of a second mobile body present in the second region;
an operation mode setting portion configured to set, by an operation of a user, content of an operation mode defining a movement condition when the first mobile body moves in the first region; and
a first mobile body control unit configured to select the operation mode based on a detection result of the second mobile body detection unit and control the first mobile body based on the selected operation mode.

17. The mobile body control system according to claim 16, further comprising:
an operation mode selection rule setting portion configured to set an operation mode selection rule, which is a rule when the operation mode is selected by the first mobile body control unit, by an operation of the user.

18. The mobile body control system according to claim 1, wherein the determination of the operation of the second mobile body is a determination of whether the second mobile body is moving.
